(19) United States
(12) Patent Application Publication
(10) Pub. No.: US 2021/0345846 A1
(43) Pub. Date: Nov. 11, 2021

(54) VACUUM CLEANER

(71) Applicant: Martti OLLILA, Helsinki (FI)

(72) Inventor: Martti OLLILA, Helsinki (FI)

(21) Appl. No.: 17/278,218

(22) PCT Filed: Sep. 3, 2019
(86) PCT No.: PCT/FI2019/000016

§ 371 Date: Mar. 19, 2021

(30) Foreign Application Priority Data
Sep. 21, 2018 (FI) 20187136

(51) Int. Cl. A47L 9/20; A47L 9/14; A47L 9/12; A47L 9/28; B01D 46/00; B01D 46/24; B01D 46/42; B01D 46/44; A47L 9/19

(52) U.S. Cl. CPC A47L 9/20; A47L 9/1409; A47L 9/127; A47L 9/2836; A47L 9/2821; B01D 2279/55; B01D 46/2403; B01D 46/4272; B01D 46/446; B01D 46/0068; A47L 9/19; B01D 46/0019

(57) ABSTRACT

Vacuum cleaner consisting of a dust container (1) and filters (2) within this, and above these a control space (3) for air and in the control space control housings (3a, 3b, 3c, 3d) and above these the central housing (4) and the underpressure space, and above this the suction unit (5) and the suction unit engine (6), all the units (1, 3, 4, 5) being in mutual communication. The control space (3) contains control valves (7, 8) for the air flow, by means of which, in normal use, the air flow is directed through the suction opening (9) in the dust container (1) to the exhaust air opening (10) in the suction unit (5) (arrows 9a, 9b, 9c) and the control valves comprise closing means, which, by opening the valve (7a) to the outside air and by closing the valve (8a) directs the air flow in the dust container in the filter under underpressure partly from the normal flow direction (9a, 9b, 9c) to the opposite flow direction (11).

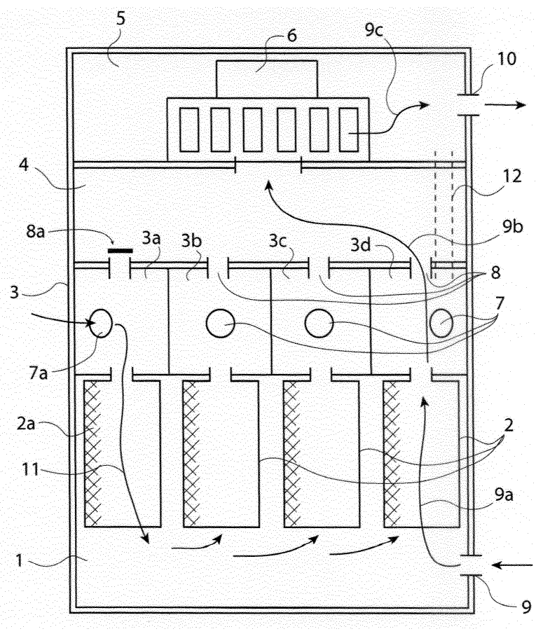

This invention relates to a vacuum cleaner, which consists of a dust container containing filters with respective different flows, and above these an air control space containing control housings, and above these a central housing and an underpressure space, and above this a suction unit and the suction unit engine, all these spaces being in mutual communication.

The purpose of the invention is to provide a vacuum cleaner of a new type, in which the filters can be cleaned with the desired effect even while the vacuum cleaner is in operation.

The vacuum cleaner of the invention is characterised in that the control space contains control valves for the air flow, by means of which the air flow in ordinary use is directed through the suction opening in the dust container to the exhaust air opening in the suction unit, in the manner indicated by the arrows, and in that the control valves have closing means, which, by opening one valve to the outside air and closing the other valve, directs the air flow in the dust container under underpressure in the filter partly from the normal flow direction into the opposite flow direction.

The filters of the vacuum cleaner are automatically cleaned, yielding a better result than manual cleaning. Using the vacuum cleaner is reasonable in terms of ecology, since the use of clean filters reduces the energy consumption and disposable filters can be abandoned. The use of the vacuum cleaner makes cleaning easier. Clean filters are crucial in terms of the operation of the vacuum cleaner. In ordinary use of the vacuum cleaner, the filters are gradually clogged and become less serviceable, and eventually practically inoperative when used over a long period of time. The vacuum cleaner of the invention has automatic operation and continuous alternate cleaning of the filters, so that the filters are never clogged and remain clean. A vacuum cleaner requires at least two filters and at least one dust container. The cleaning effect is proportional to the amount of opposite air reaching the filter. When maximum cleaning performance is desired for the filter, the entire air flow within the vacuum cleaner is directed at the cleaning stage to one single filter with opposite flow.

In this exemplifying case, part of the air flow of four filters is directed to the cleaning of one filter, whereby the amount of air relative to the filter area is multiplied at the cleaning stage compared to ordinary vacuum cleaning. When the suction opening of the dust container is completely closed, the air flow in its totality is directed to the cleaning of the filters.

The desired cleaning effect can be defined with regard to the purpose of use and the requirements. The cleaning controls of the vacuum cleaner can be manually used if necessary, or they can be programmed with the cleaning function starting automatically by electric means or starting under the joint effect of the suction air, underpressure and pressure differences in the air. The cleaning effect of the vacuum cleaner is determined by the cleaning time and the division of the air quantity in the vacuum cleaner for different functions. One single filter can be cleaned, and then the cleaning efficiency is maximal. On the other hand, if the air available for cleaning the filers is divided between several filters in the vacuum cleaner, the cleaning efficiency per filter will be reduced. The cleaning efficiency can be raised without increasing the power of the suction engine by increasing the number of filters and control housings per filter. At the same time, the filter area is kept constant. In practical operation, this involves reducing the size of the filters. The cleaning of the filters takes a few seconds for each filter. Unlike previous vacuum cleaners, this vacuum cleaner has the advantage of allowing cleaning of the filters while the vacuum cleaner is being used. The vacuum cleaner has the additional advantage of providing high cleaning performance for each filter owing to the fact that the vacuum cleaner has a separate flow tunnel and a separate closing means controlling the air flow for each of the filters. Up till now, problems have been caused by the fact that existing vacuum cleaners have not yielded the desired cleaning result due to the lack of sufficiently effective means for cleaning the filters.

The invention is described below by means of an example with reference to the accompanying drawings, which show vacuum cleaner in section. In the figures, filters 2 and the control housings 3 of the vacuum cleaner are aligned. However, in reality, they form 90° sectors which describe the cylindrical periphery of the vacuum cleaner in section.

The vacuum cleaner consists of a dust container 1 containing filters 2, and above these a control space 3 including control housings 3a, 3b, 3c, 3d and above these a central housing 4 and an underpressure space, and above this a suction unit 5 and the suction unit engine 6. Said spaces 1, 3, 4, 5 intercommunicate. Control space 3 contains control valves 7, 8 for the air flow, by means of which, in ordinary use, the air flow is directed through a partly or completely closable suction opening 9 in the dust container 1 to an exhaust air opening 10 in dust container 1, indicated by arrows 9a, 9b, 9c, the control valves having closing means, which, by opening valve 7a to the outside air and closing valve 8a, directs the air flow in the dust container under underpressure in the filter partly from the normal flow direction 9a, 9b, 9c into the opposite flow direction 11.

If the air opening in the dust container 9 closes/is closed momentarily, the air flows to the filter cleaning in its totality. The closing valves 7 and 8, for instance, are closed by means of springs, and should the suction opening 9 of the container be closed under underpressure, valve 7 opens and valve 8 closes. When the suction opening of the dust container is opened, the underpressure prevailing in the space sinks and the springs return closing valves 7 and 8 to their normal position.

An electric control sensor is also activated by underpressure. If one single filter at a time is cleaned, the foulest filter is each time selected for cleaning under the effect of underpressure, given that the most clogged filter generates the highest underpressure in the control housing. The filter is cleaned and the dust sinks into dust container 1.

The location of suction unit 5 is not necessarily immediately above the central housing 4, but may as well be anywhere else, and the unit can be connected to the central housing 4 with a hose or a pipe. Control housing 3 may also be located outside the control space, provided that it can be connected to the control space with a pipe or a hose or in any other manner.

The exhaust air opening 10 can be connected to valve 7a, for instance, which has underpressure, and thus regular and controlled air circulation is achieved.

To replace any external connection, closable by-pass tunnels 12 (indicated by a broken line) can also be mounted between suction unit 5 and the control housings, as described above. This prevents pollution or dust from entering the filters from the outside foul and/or dusty air. Filtered and clean air circulates inside the vacuum cleaner. At the same time, suction opening 9 is kept partly or completely closed.

1-8. (canceled)

9. A vacuum cleaner, which comprises a dust container, containing filters with respective different air flows, a central housing with an underpressure space, a suction unit, a suction unit engine, a suction opening, and an exhaust air opening, the dust container, the central housing and the suction unit being in mutual connection, wherein each filter is connected to a control housing and each control housing comprises a first control valve and a second control valve, by which in ordinary use, the air flow is directed from the suction opening through the filters to the exhaust air opening, and in that the control valves which, by opening the first control valve of one or more control housing(s) to the outside air and by closing the second valve of the same control housing(s), direct the air flow in the dust container through the filter(s) in connection with said control housing(s) under underpressure to the opposite flow direction compared to the normal flow direction.

10. The vacuum cleaner of claim 9 where the suction opening is arranged to be adjusted, or completely closed as necessary, when the filters are cleaned with an inner air flow using by-pass tunnels.

11. The vacuum cleaner of claim 10 where the control valves are arranged to be controlled manually, electrically or under underpressure prevailing in the vacuum cleaner.

12. The vacuum cleaner of claim 11 where one or more filters are arranged to be cleaned at a time by opening the first control valve(s) and closing the second control valve(s) of the control housing(s) connected to the filter(s).

13. The vacuum cleaner of claim 12 where the filters are arranged to be cleaned while the vacuum cleaner is in operation.

14. The vacuum cleaner of claim 11 where the filters are arranged to be cleaned while the vacuum cleaner is in operation.

15. The vacuum cleaner of claim 10 where one or more filters are arranged to be cleaned at a time by opening the first control valve(s) and closing the second control valve(s) of the control housing(s) connected to the filter(s).

16. The vacuum cleaner of claim 10 where the filters are arranged to be cleaned while the vacuum cleaner is in operation.

17. The vacuum cleaner of claim 9 where the filters are arranged to be cleaned while the vacuum cleaner is in operation.

18. The vacuum cleaner of claim 9 where the control valves are arranged to be controlled manually, electrically or under underpressure prevailing in the vacuum cleaner.

19. The vacuum cleaner of claim 9 where one or more filters are arranged to be cleaned at a time by opening the first control valve(s) and closing the second control valve(s) of the control housing(s) connected to the filter(s).

20. The vacuum cleaner of claim 9 where the vacuum cleaner comprises a sensor arranged to be activated by underpressure in the control housings of the filters.

21. The vacuum cleaner of claim 9 where the vacuum cleaner comprises an automatic operation and continuous, adjustable and alternate cleaning of the filters.

22. The vacuum cleaner of claim 9 where the filter that generates the highest underpressure in the control housing is selected each time for cleaning.
